(19) United States
(12) Patent Application Publication
(10) Pub. No.: US 2004/0070152 A1
(43) Pub. Date: Apr. 15, 2004

(54) Ventilated pump shaft seal

(76) Inventor: Robert E. Oehman JR., Raleigh, NC (US)

Correspondence Address: Christopher H. Hunter, PARKER-HANNIFIN CORPORATION, 6035 Parkland Boulevard, Cleveland, OH, 44124-4141, US

(21) Appl. No.: 10/626,962

(22) Filed: Jul. 25, 2003

Related U.S. Application Data
(60) Provisional application No. 60/401,294, filed on Aug. 5, 2002.

(51) Int. Cl. F16J 15/34

(52) U.S. Cl. 277/408

(57) ABSTRACT

A gear pump includes a housing with a drive shaft projecting out through an opening in the housing to rotate a plurality of gears. A shaft seal is fixed to the housing, and includes a cylindrical, one piece (unitary) body with an internal annular core having a central circular passage with one or more reverse internal helical or spiral grooves. The central passage closely receives the drive shaft and the groove(s) provide a pumping function as the drive shaft rotates to prevent fluid leakage along the shaft. The body of the shaft seal includes a plurality of discrete, radially extending recesses opening along an exterior annular side surface of the shaft seal and arranged in circumferentially-spaced relation to one another. An annular cooling chamber entirely and continuously circumferentially surrounds the internal core and is fluidly connected with the radial recesses to provide passive conductive cooling for the shaft seal.

### CROSS-REFERENCE TO RELATED CASES

The present application claims the benefit of the filing date of U.S. Provisional Application Serial No. 60/401,294; filed Aug. 5, 2003, the disclosure of which is expressly incorporated herein by reference.

### FIELD OF THE INVENTION

The present invention relates generally to fluid transfer devices and techniques for preventing fluid leakage along the drive shaft of the device, and more particularly to shaft seals for the drive shafts of gear pumps.

### BACKGROUND OF THE INVENTION

Shaft seals are known devices to prevent fluid leakage along a drive shaft of a pump, motor, or other fluid transfer device. In many applications, the drive shaft extends out through an opening in a housing, and while seals, bushings and/or packing may be provided around the drive shaft, fluid (typically under pressure) can leak out along the drive shaft as the drive shaft rotates. In pumps with hydrodynamic or self-lubricating seals, that is, seals where a portion of the viscous fluid being pumped is used as the lubricating fluid for the seals, bushings, etc., the fluid leakage can be even more of an issue. Fluid leakage is undesirable in many applications—particularly with gear pumps which require a constant pressure differential be maintained between the suction side and the discharge side of the pump for efficient, constant and uniform operation.

A widely-used type of shaft seal includes an internal core body which surrounds a portion of the drive shaft external to the housing and includes a geometry, such as one or more helical or spiral grooves, along an internal passage closely surrounding the drive shaft. The grooves are oriented (i.e., the grooves have a “hand” or flight direction) reverse or opposite to the direction of rotation of the shaft to cause the fluid to be “pumped” in a reverse direction along the shaft, back toward the housing, as the shaft rotates. Such a shaft seal is commonly referred to as a viscous seal. Fox, U.S. Pat. No. 4,336,213, shows an example of such a viscous seal.

One issue which has arisen with such viscous-type shaft seals is heat. As the shaft turns, the friction between the shaft and the seal creates thermal energy. The thermal energy can degrade the pumped fluid, and cause wear on the seals. In addition, the heat causes the fluid to become even less viscous—which makes it even more difficult to prevent the fluid from leaking past the seals.

Certain prior references have attempted to deal with the heat issue by adding radially-projecting fins circumferentially surrounding the shaft seal and spaced along the length of the shaft seal to increase the available surface area for heat dissipation (see, e.g., Woodcock, U.S. Pat. No. 6,264,447). Other references have suggested multiple recesses, annular cavities and channels to control the thermal energy (see, e.g., Rockwood et al., U.S. Pat. No. 5,035,436). While such efforts may be effective in certain applications, they can add cost, complexity in manufacturing and repair, and bulk/size to the shaft seal. With the emphasis in the industry for compact, easy-to-manufacture and cost-conscious components, many of the prior designs are undesirable as they require a number of parts which must be separately manufactured and then assembled. Repairing such seals is also difficult, time consuming and costly.

In addition, applicant believes that some of the designs, such as the finned shown in the above Woodcock reference, require a trade-off between thermal efficiency, size and strength. Woodcock relies on passive convective cooling for thermal management of the shaft seal. Bolts are used to fasten the shaft seal to the pump housing to keep the shaft seal securely fixed to the housing, and prevent fluid leakage between the shaft seal and the housing. With a finned design, it becomes somewhat complicated to i) position the bolts in such a manner that the shaft seal is securely fixed to the pump housing, ii) easy access to the bolts provided, and iii) the overall size of the shaft seal is minimized, while still maintaining a sufficient number of fins (with sufficient dimensions) for thermal management. The bolts can be arranged outwardly of the fins, but then the number and dimension of the fins must be reduced to provide easy access to the bolts and to minimize the size of the shaft seal (see, e.g., FIG. 7A of the above Woodcock reference). Alternatively, the bolts can extend through the fins (such as shown in FIG. 6A of the Woodcock reference), which allows the fins to be radially larger, but then the thickness of at least some of the fins has to be increased to support the bolts as they are torqued down against the housing. This reduces the number of fins and the useful surface area for heat transfer, and in either case, the effectiveness of the shaft seal as a cooling device is reduced.

Other known techniques, such as shown in the above Rockwood reference as well as in Airhart, U.S. Pat. No. 4,471,963, require cooling fluid to be continuously circulated in an internal channel of the shaft seal. While this type of design might work appropriately in certain applications, it is believed some end users have been reluctant to accept such an expense and effort of attaching fluid tubes and maintaining a continuously-circulating cooling fluid system, and so have simply left the ports in these designs unconnected, and allowed air to circulate through the internal channel in an attempt to create passive convective cooling. As can be appreciated, the inlet and drain ports for these designs are not large enough to allow a sufficient volume of air to pass through the internal channel to provide a sufficient transfer of heat energy, and as such, the effectiveness of the shaft seal as a heat transfer device in this technique is reduced if used in a passive convective cooling manner.

As such, applicant believes that there is a demand in the industry for a simple, compact, easy-to-manufacture shaft seal which maximizes, or at least increases, the heat transfer characteristics of the shaft seal using passive convective cooling to provide satisfactory thermal management for the fluid transfer device.

### SUMMARY OF THE PRESENT INVENTION

The present invention thereby provides a simple, compact, easy-to-manufacture shaft seal for the drive shaft of a fluid transfer device, which maximizes, or at least increases, the heat transfer characteristics of the shaft seal using passive convective cooling to provide satisfactory thermal management. The shaft seal of the present invention is particularly useful for gear pumps.

According to the present invention, the shaft seal has a cylindrical, one-piece (unitary) body with an internal annular core closely receiving the drive shaft. The core includes a central passage with one or more reverse internal helical or spiral grooves which provide a pumping function as the drive shaft rotates to prevent fluid leakage along the shaft. The body of the shaft seal includes a plurality of discrete, radially-extending recesses circumferentially surrounding the shaft seal and opening along an exterior annular side surface of the shaft seal. The recesses intersect (and in a preferred embodiment, actually create during the forming of the recesses) an annular cooling channel entirely and continuously surrounding the internal core.

The combination of a shaft seal having i) multiple recesses spaced around the entire circumference of the shaft seal, ii) a continuous annular cooling channel, iii) a one-piece (unitary) design, provides satisfactory and sufficient heat transfer using passive convective cooling for many applications. The shaft seal has a compact design which is relatively straight-forward to manufacture. In addition, the shaft seal has robust and rigid end walls axially interconnected by the portions of the side wall surrounding the recesses, all of which easily supports bolts passing through both end walls to securely fix the shaft seal to the pump housing.

As such, the present invention provides a simple, compact, easy-to-manufacture shaft seal for the drive shaft of a fluid transfer device, such as a gear pump, which provides thermal management using passive convective cooling.

Further features of the present invention will become apparent to those skilled in the art upon reviewing the following specification and attached drawings.

### BRIEF DESCRIPTION OF THE DRAWINGS

FIG. 1 is a side view of a fluid transfer device with a shaft seal constructed according to the principles of the present invention;

FIG. 2 is an exploded view of the fluid transfer device of FIG. 1;

FIG. 3 is a front end view of the fluid transfer device of FIG. 1;

FIG. 4 is a rear end view of the fluid transfer device of FIG. 1;

FIG. 5 is a cross-sectional side view of the fluid transfer device taken substantially along the plane described by the lines 5-5 of FIG. 3;

FIG. 6 is a cross-sectional view of the fluid transfer device taken substantially along the plane described by the lines 6-6 of FIG. 3;

FIG. 7 is a cross-sectional view of the fluid transfer device taken substantially along the plane described by the lines 7-7 of FIG. 4;

FIG. 8 is a front view of the shaft seal for the fluid transfer device of FIG. 1;

FIG. 9 is a cross-sectional side view of the shaft seal taken substantially along the plane described by the lines 9-9 of FIG. 8;

FIG. 10 is a cross-sectional view of the fluid transfer device taken substantially along the plane described by the lines 10-10 of FIG. 8;

FIG. 11 is a cross-sectional front end view of a portion of the shaft seal taken substantially along the plane described by the lines 11-11 in FIG. 5.

### DETAILED DESCRIPTION OF THE PREFERRED EMBODIMENT

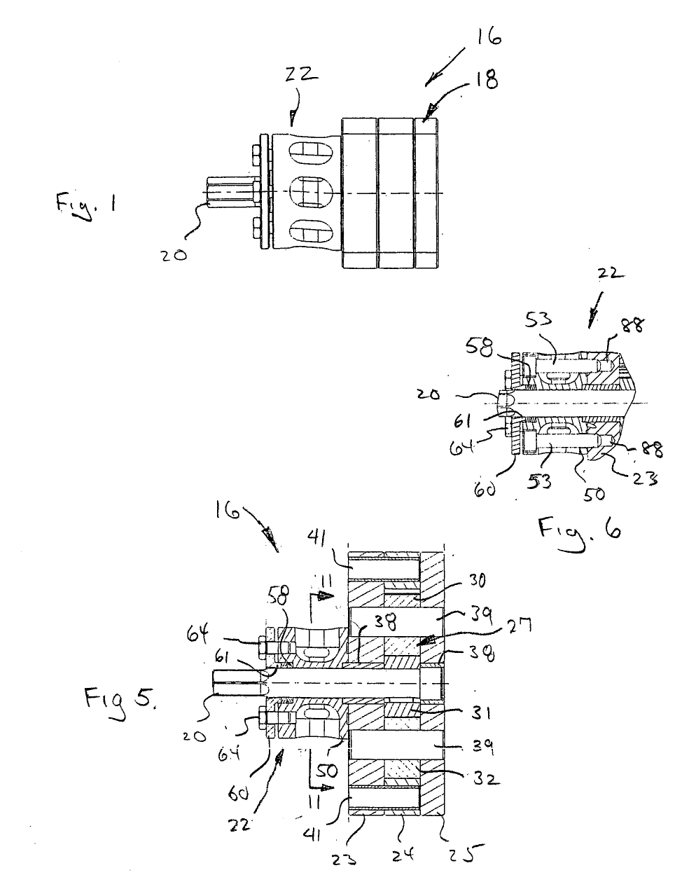

Referring to the drawings, and initially to FIG. 1, a fluid transfer device is indicated generally at 16, and includes a housing, indicated generally at 18, and a drive shaft 20 projecting exteriorly from (at least) one end of the housing. A shaft seal, indicated generally at 22, surrounds the projecting portion of the drive shaft and prevents fluid leakage along the shaft as will be described in more detail below.

The fluid transfer device 16 of the present invention could be used in a variety of applications, for example as a pump for melted synthetic fiber; as an extrusion pump; or as a petroleum distillate pump or as a hot melt adhesive pump (as only a few examples); and can be operated as a pump or motor, depending on whether the shaft is being used to move fluid, or the fluid is being used to move the shaft. This should be well-known to those skilled in the art.

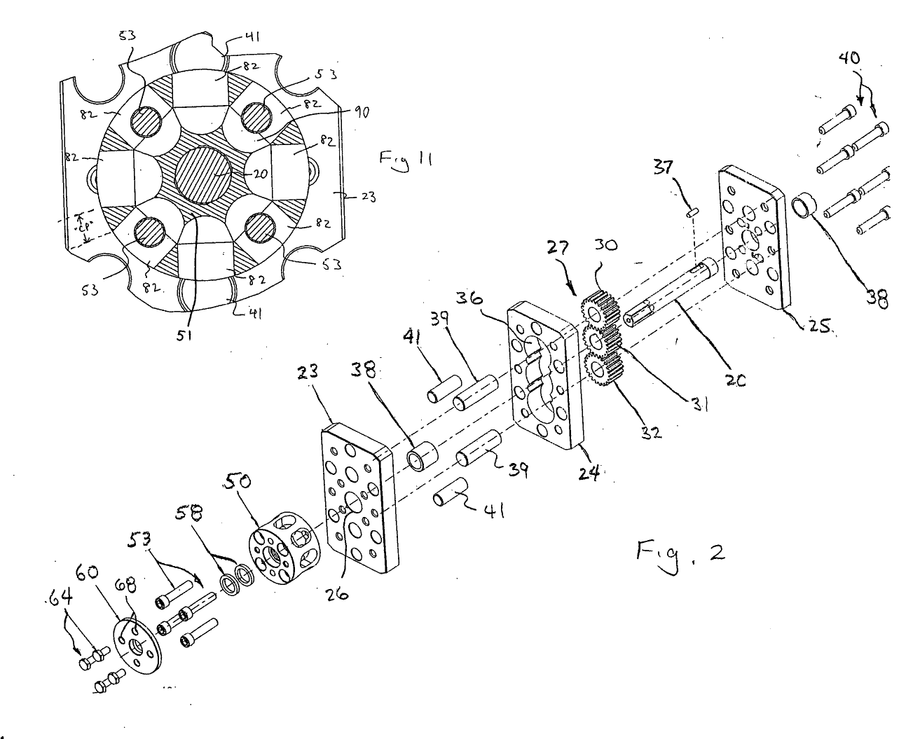

Referring now to FIGS. 2-7, the fluid transfer device is shown in more detail. Housing 18 is shown comprising a plurality of flat plates, namely a front plate 23, an intermediate gear plate 24 and a rear plate 25. Shaft 20 projects outwardly through an opening 26 in front plate 23. A pumping means, operatively connected to the drive shaft, is indicated generally at 27, and is illustrated as a gear pump, with a plurality of gears 30-32 with intermeshing teeth. The gears 30-32 are closely received and supported for rotation within an appropriately-dimensioned gear chamber 36 of gear plate 24. The intermediate gear 31 is generally referred to as a “drive gear” and is received about drive shaft 20 and journaled for rotation therewith using a key 37. Sleeve bearings 38 support the drive shaft within the front and rear plates. Gears 30, 32 are termed “driven gears” and are rotationally received about arbors 39, which are each supported by front and rear plates 23, 25. Elongated fasteners such as bolts 40 extend through appropriate bores to retain plates 23-25 in adjacent, fixed, sealed relation to one another, with the front and rear plates 23, 25 supporting opposite sides of gears 30-32. Dowel pins 41 are typically used to align the plates 23-25 during assembly.

When the gears 30-32 are so supported and the plates are assembled as described above, the gears create expanding and contracting teeth cavities as the drive shaft 20 is rotated. As shown in FIG. 4, rear plate 25 includes a pair of inlet ports 44 and a pair of outlet ports 46 which direct fluid into and out of the housing, and in particular into an area of expanding teeth cavities, and out of an area of contracting teeth cavities. The ports 44, 46 could be reversed, that is the inlet port could be the outlet port, and vice-versa, depending on the desired direction of rotation of shaft 20. In any case, each port is configured to receive an appropriate fitting for connection within a fluid system, as should be known to those skilled in the art.

While two fluid paths using three gears is illustrated, it should be appreciated that this is only one example of a gear pump that can be used with the present invention, and that a gear pump with only a single fluid path using only two gears, or a gear pump with multiple fluid paths using more than three gears (or any variant thereof) could likewise be used with the present invention. Likewise, the housing of the gear pump is shown as including three plates. Again, this could vary, and it may be possible to construct the housing of one, two or more than three plates, depending upon the particular application. In any case, the operation and structure of the gear pump will not be described further, as it is believed this is well-known to those skilled in the art and can vary depending upon the particular application. Resort may be had to the prior references identified above, such as Fox, U.S. Pat. No. 4,336,213, for a more detailed explanation of the structure and operation of a gear pump. Moreover, on a more general level, it should be appreciated that a gear pump is only one example of pumping means for a fluid transfer device that can be used with the present invention, and that the present invention is useful with other types of pumping means, as long as the fluid transfer device has a rotating shaft that has a need for a shaft seal.

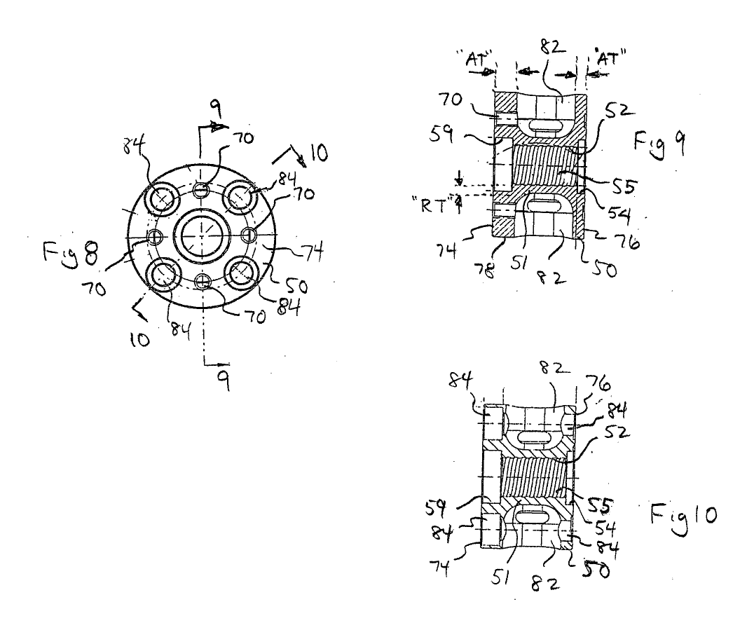

Referring now FIGS. 2, 3 and 5-8, the shaft seal 22 includes a cylindrical body 50 which is formed unitarily, in one piece. The body has an internal annular core 51 with a central, axially-extending circular passage 52 which closely receives drive shaft 20. A plurality of elongated fasteners, such as bolts 53, securely fix shaft seal 22 to the front plate 23 of housing 18. Bearing sleeve 38 in front plate 23 projects slightly outwardly from the front plate, and is received in a short counterbore 54 in the rear end of the shaft seal body to facilitate locating the shaft seal with respect to the housing 18 (sec, e.g., FIGS. 5, 6 and 7). Passage 52 in the shaft seal preferably includes a labyrinth groove or channel geometry, such as one (or more) helical or spiral grooves 55 shown in FIGS. 9 and 10. Groove(s) 55 have an opposite or reverse “hand” or flight direction as the rotation of shaft 20, such that when shaft 20 rotates, the grooves “pump” any fluid leaking down along shaft 20 back toward the housing 18.

If necessary or desirable, one or more packing or lip seals 58 can be provided in a counterbore 59 at the outer end of the shaft seal, around shaft 20, to provide a static, fluid tight seal between shaft 20 and body 50. An annular packing gland 60 with an internal annular flange 61 (see FIGS. 5-7) can be fixed to the end of the shaft seal with bolts 64 to retain the packing seals in counterbore 59 and around the drive shaft. Bolts 64 are received in through-bores 68 (FIG. 2) in packing gland 60, and corresponding threaded bores 70 (FIGS. 8, 9) in body 50.

The above is conventional structure and function for a viscous seal, and will not be described further for sake of brevity.

It is noted that while the present invention is particularly useful for shaft seals using a viscous seal, it is believed the principles of the present invention are applicable to shaft seals where other types of seals are used around the drive shaft, for example, an annular packing, lip seal, bushing, O-ring, or other type of annular seal device. It is believed the cooling features of the present invention would work just as effectively with such other types of seal devices.

Referring now to FIGS. 8-11, the body 50 of the shaft seal is shown as having a front flat annular end wall 74 at one end of the shaft seal, an opposite rear flat annular end wall 76, at the other end of the shaft seal, and a cylindrical outer side wall 78 extending between and interconnecting the front and rear end walls. The outer side wall 78 preferably has a substantially continuous radial dimension along the entire length of the shaft seal. Rear end wall 76 is positioned in surface-to-surface relation with the outer surface of the front housing plate when the shaft seal is fixed to the fluid transfer device. A series of radially-extending, discrete recesses 82 are formed around the shaft seal, and open radially outwardly along the side wall 78. The recesses preferably have a slotted or axially-elongated configuration, and a depth to maximize, or at least increase, the volume available for air flow. Preferably eight of such recesses 82 are formed in an even, spaced apart arrangement (see, e.g., FIG. 11), however it should be appreciated that the number and configuration of such recesses may vary, and will be determined primarily based upon the desired heat transfer characteristics of the shaft seal. Nevertheless, it is preferred that the recesses be spaced around the entire circumference of the shaft seal for satisfactory air flow.

As shown in FIG. 11, a continuous annular cooling channel 90 is provided around the entire core 51. The recesses all radially intersect the annular cooling channel. The cooling channel 90 is thereby fluidly connected to all the recesses 82 and provides a passage to allow air flow through the shaft seal for passive convective cooling.

The configuration of the recesses and the cooling channel is based on the desired structural requirements of the shaft seal. For example, the radial depth of the cooling channel, axial length of the channel and recesses, and the circumferential spacing of the recesses are sufficient to maximize the available volume of air flow through the shaft seal to cool the inner core 51 of the shaft seal; however, they are not so much as to compromise the structural integrity of the shaft seal. As such, the radial thickness “RT” (see FIG. 9) of the core 51 of the shaft seal body remaining between the cooling channel and the central passage 52 is sufficient to prevent bending or rupturing of the central portion of the shaft seal. Likewise, the axial thickness “AT” of the end walls 76, 78 of the shaft seal body remaining between the ends of the channel and recess and the ends of the shaft seal; and the circumferential portions “CP” (FIG. 11) of the shaft seal body remaining between adjacent recesses, is sufficient to prevent bending or deforming of the shaft seal during the torquing down of bolts 64 against housing 18. Preferably, the recesses 82 encompass more of the available surface area around the shaft seal than the body portions between the recesses (i.e., the portions referred to above as “CP”), however, again, this can vary depending upon the particular application.

It is believed that in most applications, a satisfactory flow of air through the recesses and the cooling passage is achieved, if the surface area around the side wall of the shaft seal encompassed by the recesses is greater than the surface area of the remaining portions of the side wall, surrounding the recesses.

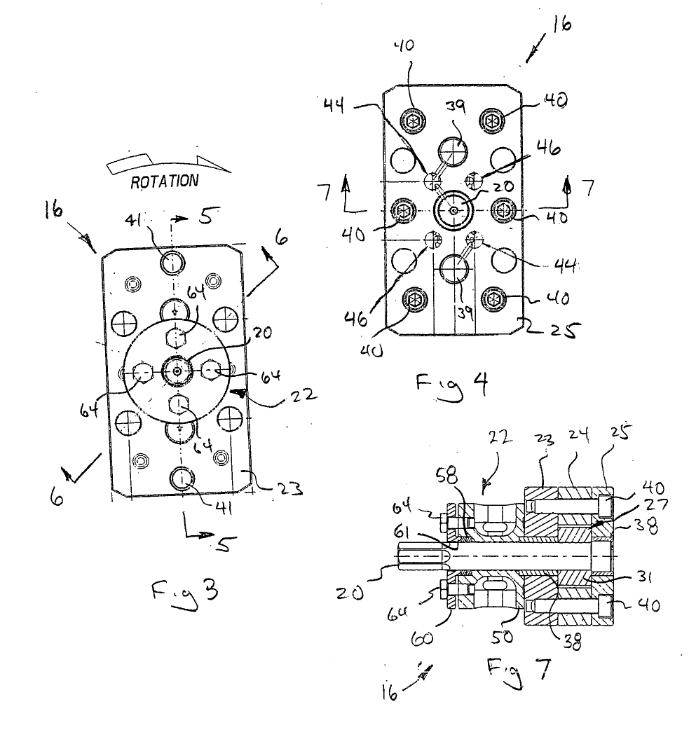

As can be seen in FIG. 6, bolts 53 extend completely internally along the entire length of the shaft seal, through bores 84 (FIGS. 8, 10) formed in the front and rear walls 76, 78, and into corresponding threaded blind-end bores 88 formed in the front surface of front plate 23. The bolts are illustrated as passing through certain of the recesses 82 and the cooling channel 90, between the end walls; however, they may also extend through the solid portions of the shaft seal.

The body 50 of the shaft seal is formed of a material (e.g., steel or bronze) appropriate for the particular application, and as indicated above, is preferably formed as a unitary, one-piece component. Using a machining technique such as a ball-nosed end mill, for example, the slotted recesses can be cut in a solid cylinder to an appropriate depth. In so doing, the annular cooling channel 90 interconnecting all of the recesses, can also be formed at the same time. This reduces the steps necessary to form the recesses and annular channel, when the annular cooling channel is created, in effect, at the same time as the recesses. Other techniques, such as casting, EDM or drilling, could also be used to create recesses which intersect at the bottom so as to form the continuous cooling channel. The central passage 52, with its internal helical or spiral groove(s), can then be formed using other common machining techniques. Overall, the shaft seal can be formed by using simple, widely-known machining (or other) techniques in a minimum number of steps.

Moreover, the shaft seal could be formed of a non-metal, such as a carbon, silicon carbide, ceramic or plastic. These materials could also be formed (e.g., molded) in such a way as to produce multiple recesses and a continuous internal cooling channel.

The combination of multiple recesses and a continuous cooling channel in a one-piece shaft seal design provides sufficient heat transfer using passive convective cooling for many applications. The shaft seal has relatively compact design which is relatively simple to manufacture. In addition, the shaft seal has robust and rigid end walls, axially interconnected by portions of the side wall, and bolts can pass through the end walls to securely fix the shaft seal to the pump housing without causing damage to the shaft seal, and without compromising the thermal management properties of the shaft seal.

As such, as described above, the present invention provides a simple, compact, easy-to-manufacture shaft seal for the drive shaft of a fluid transfer device, such as a gear pump, which uses passive convective cooling to provide appropriate thermal management, and which overcomes at least some of the drawbacks of prior techniques.

The principles, preferred embodiments and modes of operation of the present invention have been described in the foregoing specification. The invention which is intended to be protected herein should not, however, be construed as limited to the particular form described as it is to be regarded as illustrative rather than restrictive. Variations and changes may be made by those skilled in the art without departing from the scope and spirit of the invention as set forth in the appended claims.

What is claimed is:

1. A shaft seal for passive convective cooling of a rotatable shaft, the shaft seal comprising:
a cylindrical body including an internal annular core, the core having a central, axially-extending circular passage with at least one reverse internal helical or spiral groove for closely receiving the shaft and providing a pumping function as the shaft rotates to prevent leakage of fluid along the shaft, the body of the shaft seal including a plurality of discrete, radially extending recesses opening along an exterior surface of the shaft seal and arranged in circumferentially-spaced relation to one another, and an annular cooling passage entirely and continuously circumferentially surrounding the internal core and fluidly connected with the radial recesses to provide thermal management for the shaft seal.

2. The shaft seal as in claim 1, wherein the body of the shaft seal is a one piece, unitary component.

3. The shaft seal as in claim 1, wherein the body of the shaft seal has an outer cylindrical side wall, and the radial recesses open along the outer cylindrical side wall.

4. The shaft seal as in claim 3, wherein the radial recesses are evenly-spaced around the side wall.

5. The shaft seal as in claim 3, wherein the surface area around the outer cylindrical side wall encompassed by the recess openings is greater than the surface area of the remaining portions of the side wall, surrounding the openings.

6. The shaft seal as in claim 1, wherein the radial recesses are axially elongated.

7. The shaft seal as in claim 1, wherein the body of the shaft seal includes a first annular end wall at one end of the shaft seal, and an opposite annular end wall, axially spaced from the first end wall, at an opposite end of the shaft seal.

8. The shaft seal as in claim 7, wherein the body of the shaft seal includes a series of axial throughbores extending between and interconnecting the end walls, and a series of elongated fasteners can be received in the throughbores to fixedly attach the shaft seal to a housing.

9 The shaft seal as in claim 7, wherein the body of the shaft seal has an outer cylindrical side wall, extending between and interconnecting the end walls.

10. The shaft seal as in claim 9, wherein the side wall has a substantially constant radial dimension along the entire length of the shaft seal between the end walls.

11. The shaft seal as in claim 1, wherein the recesses radially intersect the cooling passage.

12. A gear pump and shaft seal combination, comprising:
a housing assembly including a plurality of plates, and inlet and outlet ports in the housing assembly;
a plurality of gears having intermeshing teeth, said gears supported for rotation between the plates, the inlet and outlet ports providing fluid flow into an area of expanding cavities between the teeth, and providing fluid flow out of an area of contracting cavities between the teeth, one of said gears being supported for rotation on a drive shaft, said drive shaft projecting axially through an opening in one of said plates and externally of the housing assembly to enable rotation of the gears;
the shaft seal fixed to the one plate, and including a cylindrical body with an internal annular core having a central circular passage with a reverse internal helical or spiral groove, the central passage closely receiving an external portion of the drive shaft and the reverse internal groove providing a pumping function as the drive shaft rotates to prevent leakage of fluid from the housing along the drive shaft, the body of the shaft seal including a plurality of discrete, radially extending recesses opening along an exterior surface of the shaft seal and arranged in circumferentially-spaced relation to one another, and an annular cooling passage entirely and continuously circumferentially surrounding the internal core and fluidly connected with the radial recesses to provide passive convective cooling for the shaft seal as the drive shaft rotates.

13. The combination as in claim 12, wherein the body of the shaft seal is a one piece, unitary component.

14. The combination as in claim 12, wherein the body of the shaft seal has an outer cylindrical side wall, and the radial recesses open along the outer cylindrical side wall.

15. The combination as in claim 14, wherein the radial recesses are evenly-spaced around the circumference of the outer cylindrical side wall.

16. The combination as in claim 14, wherein the surface area around the outer cylindrical side wall encompassed by the recess openings is greater than the surface area of the remaining portions of the side wall, surrounding the openings.

17. The combination as in claim 12, wherein the radial recesses are axially elongated.

18. The combination as in claim 12, wherein the body of the shaft seal includes a first annular end wall at one end of the shaft seal in abutting relation with an outer surface of the one plate, and an opposite annular end wall, axially spaced from the first end wall, at an opposite end of the shaft seal.

19. The combination as in claim 18, wherein the shaft seal body includes a series of axial throughbores extending between and interconnecting the end walls, and a plurality of elongated fasteners are received in the throughbores to fixedly attach the shaft seal to the one plate of the housing.

20. The combination as in claim 19, wherein the axial throughbores are arranged such that the fasteners pass internally through the entire length of the shaft seal.

21. The combination as in claim 18, wherein the body of the shaft seal has an outer cylindrical side wall, extending between and interconnecting the end walls.

22. The combination as in claim 12, wherein the side wall has a substantially constant radial dimension along the entire length of the shaft seal between the end walls.

23. The combination as in claim 12, wherein the recesses radially intersect the cooling passage.

24. A fluid transfer device and shaft seal combination, comprising:
a housing including inlet and outlet ports;
pump means supported in the housing, the inlet and outlet ports directing fluid to and away from the pump means, a rotatable drive shaft projecting axially externally of the housing operatively connected to the pump means;
the shaft seal fixed with respect to the housing, and including a one piece, unitary body with an internal core circumferentially surrounding the shaft, the internal core including a central passage closely receiving an external portion of the drive shaft and seal means along an interior surface of the central passage for preventing fluid leakage along the drive shaft as the drive shaft rotates,
the body of the shaft seal including a plurality of discrete, radially-extending recesses opening along an exterior side surface of the shaft seal, and a cooling chamber entirely and continuously surrounding the internal core and fluidly connected with the radial recesses to provide passive conductive cooling for the shaft seal as the drive shaft rotates.

25. The combination as in claim 24, wherein the radial recesses are evenly-spaced around the circumference of the shaft seal body.

26. The combination as in claim 24, wherein the surface area of the side surface of the shaft seal encompassed by the recess opening is greater than the surface area of the remaining portions of the side surface, surrounding the recess openings.

27. The combination as in claim 23, wherein the radial recesses are axially elongated.

28. The combination as in claim 24, wherein the body of the shaft seal includes a first end wall at one end of the shaft seal in abutting relation with an outer surface of the housing, and an opposite end wall, axially spaced from the first end wall, at an opposite end of the shaft seal.

29. The combination as in claim 28, wherein the body of the shaft seal includes a series of axial throughbores extending between and interconnecting the end walls, and a plurality of elongated fasteners are received in the throughbores to fixedly attach the shaft seal to the housing.

30. The combination as in claim 29, wherein the axial throughbores are arranged such that the fasteners pass internally through the entire length of the shaft seal.

31. The combination as in claim 23, wherein the body of the shaft seal has a substantially constant exterior dimension along the entire length of the seal between the end walls.

32. The combination as in claim 24, wherein the recesses radially intersect the cooling passage.
